(19) United States
(12) Patent Application Publication
(10) Pub. No.: US 2003/0016493 A1
(43) Pub. Date: Jan. 23, 2003

(54) Electronic apparatus with first unit affected easily by vibration and second unit generating vibration in operation

(75) Inventors: Shinji Hiratomo, Ome-shi (JP); Yuji Nakajima, Nishitama-gun (JP); Eiji Hashimoto, Nishitokyo-shi (JP); Yosuke Miura, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/187,627

(22) Filed: Jul. 3, 2002

(30) Foreign Application Priority Data
Jul. 5, 2001 (JP) 2001-204887

(51) Int. Cl. G06F 1/16

(52) U.S. Cl. 361/685; 248/636; 248/618; 369/77.2

(57) ABSTRACT

An electronic apparatus including a first unit and a second unit connected to the first unit. The first unit having an electronic device and a first supporting member. The second unit having a vibration generating device and a second supporting member. A first damper is attached to the first supporting member. A second damper is attached to the second supporting member.

### CROSS-REFERENCE TO RELATED APPLICATIONS

This application is based upon and claims the benefit of priority from the prior Japanese Patent Application No. 2001-204887, filed Jul. 5, 2001, the entire contents of which are incorporated herein by reference.

### BACKGROUND OF THE INVENTION

1. Field of the Invention

The present invention relates to an electronic apparatus comprising a first unit that includes an electronic device such as a hard disk drive and a second unit that has a vibration generating device such as a loudspeaker. In particular, the invention relates to a structure for cutting off the transmission of vibration from the second unit to the first unit.

2. Description of the Related Art

For example, for a note type of portable computer, various optional electronic devices are prepared for improving convenience for its use. As an electronic apparatus of this kind, an apparatus that is provided with a first unit including an electronic device such as a hard disk drive and a pair of second units, each having a loudspeaker, has been widely known.

The first unit has a box type of a first housing. The first housing includes the electronic device, and is positioned on, for example, a top plane of a desk. Each of the second units has a box type of a second housing, and includes the loudspeaker. The second housings are separately disposed with interposing the first housing therebetween, and mounted to the first housing, respectively, through a plurality of screws.

In a conventional electronic apparatus, the first unit and the second unit are directly connected with each other. Therefore, it cannot be avoided that vibration that is caused when the loudspeaker utters sound is transmitted from the second unit to the electronic device in the first unit. In particular, it is not preferable that the hard disk drive, which is a precision device, is used in the way that impact or vibration is transmitted thereto. Therefore, in the case that the vibration is transmitted to the hard disk drive from the loudspeaker, an operation error is apt to occur therein. The operation error in the hard disk drive often occurs in the case that a high quality loudspeaker, which emphasizes middle and low tones, is employed.

To solve the problem described above, it has been attempted that the first and second units are separated from each other. However, when the first and the second units are disposed side by side on the top plane of the desk, the first and second units come into the state where they are indirectly connected to each other through the top plane. Therefore, the vibration caused by the loudspeakers is transmitted from the second unit to the first unit through the top plane, and it is not thus possible to cut off the vibration to be transmitted to the hard disk drive.

In addition, since the first and second units are separated from each other, the plural units become troublesome to handle in the case that, for example, the electronic apparatus is carried.

An object of the present invention, which has been achieved in view of the situation described above, is to provide an electronic apparatus capable of unfailingly cutting off transmission of the vibration from the second unit to the first unit, and thus preventing an operation error in the precision device from occurring.

### BRIEF SUMMARY OF THE INVENTION

To achieve the above object, electronic apparatus according to a first aspect of the invention is characterized by comprising:

a first unit including an electronic device and a first supporting member;

a first damper attached to the first supporting member for absorbing vibration;

a second unit having a vibration generating device and a second supporting member, the second unit connected to the first unit; and

a second damper attached to the second supporting member for absorbing vibration.

According to the construction described above, the vibration of the vibration generating device is absorbed by the first and second dampers before the vibration reaches the first unit.

Accordingly, the vibration, which is likely to be transmitted from the second unit to the first unit, is damped over two stages. As a result, the vibration to be transmitted to the first unit can be cut off unfailingly, so that the vibration of the vibration generating device does not affect the electronic device.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a cross-sectional view of an electronic apparatus according to the first embodiment of the invention, showing the state where the first and second units are disposed on a mounting plane;

FIG. 2 is a perspective view of the first damper;

FIG. 3 is a perspective view of the second damper;

FIG. 4 is a perspective view of the third and fourth dampers;

FIG. 5 is a cross-sectional view taken along the line A-A in FIG. 1;

FIG. 6 is a cross-sectional view of an electronic apparatus according to the second embodiment of the invention, showing the state where a hard disk drive is supported to the second housing through the fifth and sixth dampers;

FIG. 7 is a perspective view of the fifth damper to be used in the second embodiment of the invention;

FIG. 8 is a perspective view of the sixth damper to be used in the second embodiment of the invention;

FIG. 9 is a cross-sectional view of an electronic apparatus according to the third embodiment of the invention, showing the state where a hard disk drive is supported to the second housing through the fifth and sixth dampers; and

FIG. 10 is a perspective view of the fifth damper to be used in the third embodiment of the invention.

### DETAILED DESCRIPTION OF THE INVENTION

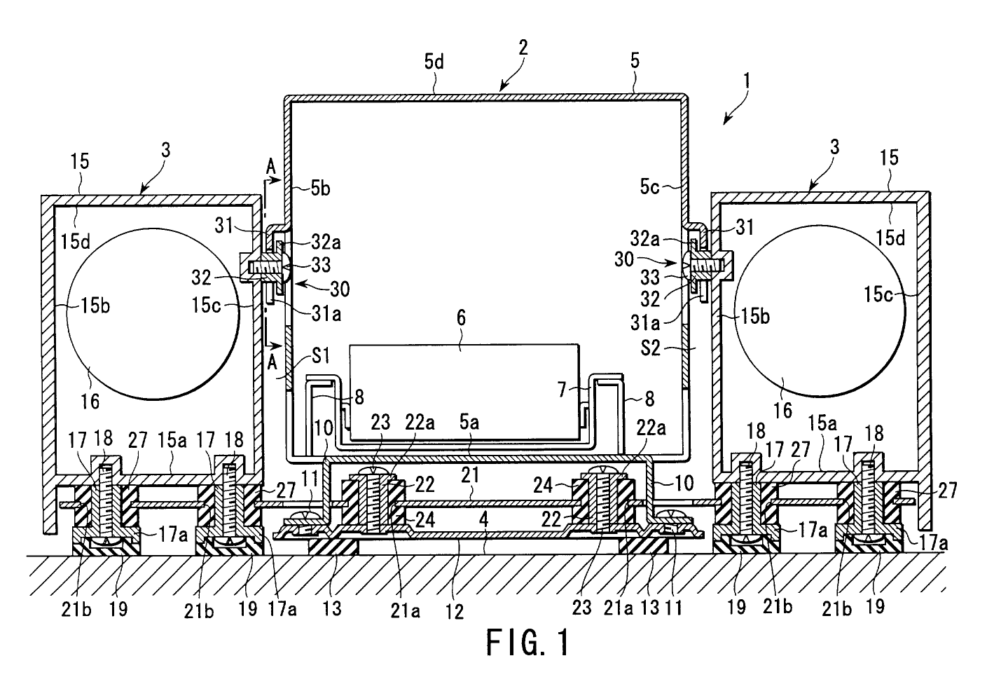

The first embodiment of the invention now will be described with reference to FIG. 1 to FIG. 5.

FIG. 1 illustrates an optional electronic apparatus 1 that is connected to, for example, a portable computer for use. The electronic apparatus 1 comprises a first unit 2 and a pair of second units 3. The first unit 2 and the second units 3 are disposed on a flat mounting plane 4 such as a top plane of a desk.

The first unit 2 comprises a box-type first housing 5. The first housing 5 has a bottom wall 5a, a left side wall 5b, a right side wall 5c, and a top wall 5d. The first housing 5 also contains a hard disk drive 6. The hard disk drive 6 is a kind of ultra precision device that is affected easily by impact or vibration, and supported by a first bracket 7. The first bracket 7 is supported by a plurality of second brackets 8, which project upward from the bottom wall 5a. Thus, the hard disk drive 6 is supported by the bottom wall 5a of the first housing 5.

The first housing 5 has a plurality of legs 10. The legs 10 project downward from the bottom wall 5a of the first housing 5. The respective lower ends of the legs 10 are fixed on a base 12 through screws 11. The base 12 is a first support member, and is disposed horizontally extending over the legs 10. The base 12 has a bottom opposing to the mounting plane 4.

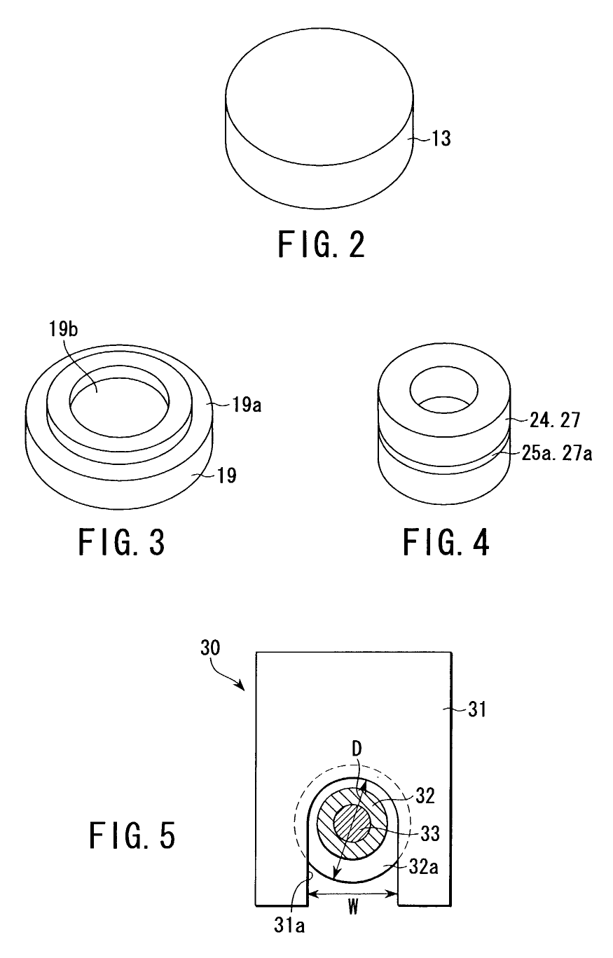

A plurality of first dampers 13 is bonded at the outer circumferential portion in the bottom of the base 12. The first dampers 13 are formed of a rubber-like elastic body that can be elastically deformed, or are made of a gel material. The first dampers 13 are cylindrical as shown in FIG. 2. Therefore, the first housing 5 of the first unit 2 is mounted on the first dampers 13 in the mounting plane 4.

The second units 3 are arranged side by side, with the first housing 2 interposed between them. The second units 3 have the same structure. Therefore, only the left second unit 3 will be described below.

As shown in FIG. 1, the second unit 3 comprises a box-type second housing 15. The second housing 15 has a bottom wall 15a, a left side wall 15b, a right side wall 15c, and a top wall 15d. The second housing 15 contains a loudspeaker 16 that is a vibration generating device. A plurality of cylindrical second supporting members 17 is fixed to the bottom wall 15a of the second housing 15 by means of screws 18. The supporting members 17 project downward from the bottom 15a. Flanges 17a are formed integral with the lower ends of the supporting members 17. The flange 17a protrude horizontally and outwardly in the diameter of the supporting members 17. The flanges 17a each have a flat bottom opposing to the mounting plane 4.

Second dampers 19 are bonded to the bottoms of the flange 17a, respectively. Each second dampers 19 is formed of a rubber-like elastic body that can be elastically deformed, or is made of a gel material. The second dampers 19 are cylindrical as shown in FIG. 3. They have an escape section 19a and a recess 19b. The escape section 19a is formed at the outer circumferential of the top of the second damper 19. The outer circumferential edge of the flange portion 17a is fitted in the escape section 19a. The recess 19b is made in the center of the top of the second damper 19. The head of each screw 18 is in the recess 19b. Therefore, the second housing 15 of the second unit 3 is disposed on the second dampers 19 in the mounting plane 4.

As shown in FIG. 1, the first unit 2 and the second unit 3 are connected by a connecting member 21. The connecting member 21 is a metal plate. The connecting member 21 is positioned under the first unit 2 and the second unit 3, while extending over the first housing 5 of the first unit 2 and the second housing 15 of the second unit 3.

The center portion of the connecting member 21 extends horizontally between the bottom wall 5a of the first housing 5 and the base 12. The center portion of the connecting member 21 has a plurality of first engaging holes 21a. The first engaging holes 21a are round ones. The base 12 has an upper surface opposing the connecting member 21. A plurality of cylindrical supporting members 22 is fixed on the upper surface of the base 12 by screws 23. Each of the supporting members 22 passes through the first engaging holes 21a coaxially. A flange 22a is formed integral with the upper end of the supporting member 22. The flange 22a protrudes horizontally and outwardly in the diameter of the supporting member 22.

Third dampers 24 are fit around supporting members 22. The third dampers 24 are rubber-like elastic bodies that can be elastically deformed, or are made of a gel material. The third dampers 24 are cylindrical as shown in FIG. 4. The third dampers 24 lie between the upper surface of the base 12 and the flange 22a of the supporting member 22, and pass through the first engaging holes 21a of the connecting member 21. An engaging groove 25a is made in the outer circumferential surface of each third damper 24. The engaging groove 25a continues is an annular one extending in the circumferential direction of the third damper 24. In the grooves 25a, an edge of the first engaging hole 21a in the connecting member 21 is opened. Therefore, the third dampers 24 connect the center portion of the connecting member 21 to the base 12 of the first housing 5.

As FIG. 1 shows, the end portions of the connecting member 21 are positioned between the bottom wall 15a of the second housing 15 and the mounting plane 4. Each end portion of the connecting member 21 has a plurality of second engaging holes 21b. The second engaging holes 21b are round ones. The supporting members 17 passes through the first engaging holes 21b coaxially.

Fourth dampers 27 are fit around each supporting members 17. The fourth dampers 27 are rubber-like elastic bodies that can be elastically deformed, or are made of gel material. The fourth dampers 27 have the same shape as the third dampers 24. The fourth dampers 27 lie between the bottom wall 15a of the second housing 15 and the flanges 17a formed at the lower end of the supporting members 17. Therefore, the flanges 17a of the supporting members 17 are positioned between the second dampers 19 and the fourth dampers 27. In other words, the second dampers 19 and the fourth dampers 27 are piled one above another, with the flanges 17a interposed between them.

The fourth dampers 27 pass through the second engaging holes 21b of the connecting member 21. An engaging groove 27a is made on the outer circumferential surface of each fourth damper 27. The engaging groove 27a is an annular one extending in the circumferential direction of the fourth damper 27. In the damper 27, an edge of the second engaging hole 21b in the connecting member 21 is opened. Therefore, the end portion of the connecting member 21 is connected to the second housing 15 through the fourth dampers 27.

In the state where the first housing 5 and the second housing 15 are connected through the connecting member 21, the first housing 5 and the second housing 15 are kept in the non-contact state. More specifically, a space S1 is prepared between the side wall 5b of the first housing 5 and the side wall 15c of the left second housing 15. In the same manner, a space S2 is prepared between the side wall 5c of the first housing 5 and the side wall 15b of the right second housing 15. With the spaces S1 and S2, the vibration is prevented from transmitting from the second housing 15 to the first housing 5.

As shown in FIG. 1, the electronic apparatus 1 comprises a pair of stopper mechanisms 30, which regulate the mutual inclination between the first housing 5 and the second housing 15. The stopper mechanisms 30 are positioned above and far from the connecting member 21, and contained in the spaces S1 and S2. Two of the stopper mechanisms 30 have the same structure, and thus one of them will be described as a representative.

As shown in FIGS. 1 and 5, the stopper mechanism 30 comprises a first engaging member 31 and a second engaging member 32. The first engaging member 31 has the form of a flat plate, and is formed integrated with the side wall 5b of the first housing 5. The engaging member 31 protrudes toward the space S1, and is arranged in parallel to the side wall 5b. The engaging member 31 is not in contact with the side wall 15c of the second housing 15, but is opposed thereto. Further, the engaging member 31 has a notch 31a opened at the lower edge thereof.

The second engaging member 32 has a cylindrical shape, and is fixed on the side wall 15c of the second housing 15 by means of a screw 33. The second engaging member 32 protrudes toward the space S1, and passes through the notch 31a of the first engaging member 31. The respective edges of the second engaging member 32 and the notch 31a are kept in the non-contact state as long as the first unit 2 and the second unit 3 are disposed on the mounting plane 4.

The second engaging member 32 has a flange 32a at the tip thereof. The flange 32a has a disc-like shape, whose diameter D is wider than the width dimension W of the notch 31a. The flange 32a is interposed between the first engaging member 31 and the side wall 5b of the first housing 5, and is kept in the non-contact state as long as the first unit 2 and the second unit 3 are disposed on the mounting plane 4.

In the construction described above, the second housings 15 containing the loudspeakers 16 are disposed on the mounting plane 4 with spaces S1 and S2 against the first housing 5. Therefore, the vibration, which is caused when the loudspeakers 16 utter sound, is transmitted to the second housings 15. Further, the vibration is apt to be transmitted to the mounting plane 4 from the second housings 15. However, the second housings 15 are disposed on the mounting plane 4 through the elastically deformable second dampers 19. Therefore, the vibration of the loudspeakers 16, which has been transmitted to the second housings 15, is absorbed and damped by the second dampers 19 prior to its transmission to the mounting plane 4. Thereby, the vibration to be transmitted from the second housings 15 to the mounting plane 4 becomes feeble.

The feeble vibration transmitted to the mounting plane 4 is apt to be transmitted to the first housing 5 through the base 12 and legs 10. In this case, the base 12 of the first housing 5 is disposed on the mounting plane 4 through the elastically deformable first dampers 13. Thus, the feeble vibration transmitted to the mounting plane 4 from the second housing 15 is absorbed again by the first dampers 13 prior to its transmission to the base 12, thereby being damped. As a result, the transmission of the vibration from the mounting plane 4 to the first housing 5 is cut off.

On the other hand, the first housing 5 and the second housings 15 are connected through the connecting member 21, so that the vibration transmitted from the loudspeakers 16 to the second housings 15 is apt to be transmitted to the first housing 5 through the connecting member 12.

However, the end portions of the connecting member 21 are connected to the respective second housings 15 through the elastically deformable fourth dampers 27. Therefore, the vibration of the loudspeakers 16, which has been transmitted to the second housings 15, is absorbed and damped by the fourth dampers 27 prior to its transmission to the connecting member 21. As a result, the vibration to be transmitted from the second housings 15 to the connecting member 21 becomes feeble.

The feeble vibration transmitted to the connecting member 21 is apt to be transmitted to the first housing 5 from the connecting member 21. In this case, the center portion of the connecting member 21 is connected to the base 12 of the first housing 5 through the third dampers 24. Therefore, the feeble vibration transmitted to the connecting member 21 is absorbed again in the third dampers 24 prior to its transmission to the base 12, thereby being damped. As a result, the transmission of the vibration from the connecting member 21 to the first housing 5 is cut off.

Consequently, the transmission of the vibration from the second housings 15 to the first housing 5, which occurs when the loudspeakers 16 utter sound, is unfailingly cut off. As a result, the hard disk drive 6, which is easily affected by impact or vibration, can be protected from the vibration of the loudspeakers 16, so that an operation error in the hard disk drive 6 can be prevented from occurring.

Furthermore, since the first unit 2 and the second unit 3 are connected to each other through the connecting member 21, the units have one integral structure. Therefore, the electronic apparatus 1 can be handled easily in carrying.

According to the construction described above, the second units 3 containing the loudspeakers 16 are supported by the end portions of the connecting member 21. Therefore, when the first housing 5 is lifted up for carrying the electronic apparatus 1, for example, the weight of the second units 3 is inflicted to the end portions of the connecting member 21. As a result, the connecting member 21 is deformed into a bow shape, so that the second units 3 may be leaned toward the direction in that the second units 3 move away from the first unit 2.

However, when the second units 3 lean, the flange 32a move toward the direction in that the flange come close to the first engaging members 31, and knock against the first engaging members 31. As a result, the second housings 15 are prevented from leaning, and the position relation between the first unit 2 and the second units 3 is maintained uniformly. In other words, the collapse in the position of the second housings 15 can be solved.

Consequently, the second units 3 can be supported by both the connecting member 21 and the stopper mechanisms 30, so that the electronic apparatus 1 can be carried easily. In addition to that, the deflection of the connecting member 21 can be suppressed, so that the connecting member 21 can be prevented from being damaged.

Furthermore, the respective first engaging members 31 and the second engaging members 32 are kept in the state non-contacting with each other as long as the first unit 2 and the second units 3 are disposed on the mounting plane 4. Therefore, the vibration of the loudspeakers 16, which has been transmitted to the second housings 15, is not transmitted to the first housing 5 through the stopper mechanisms 30.

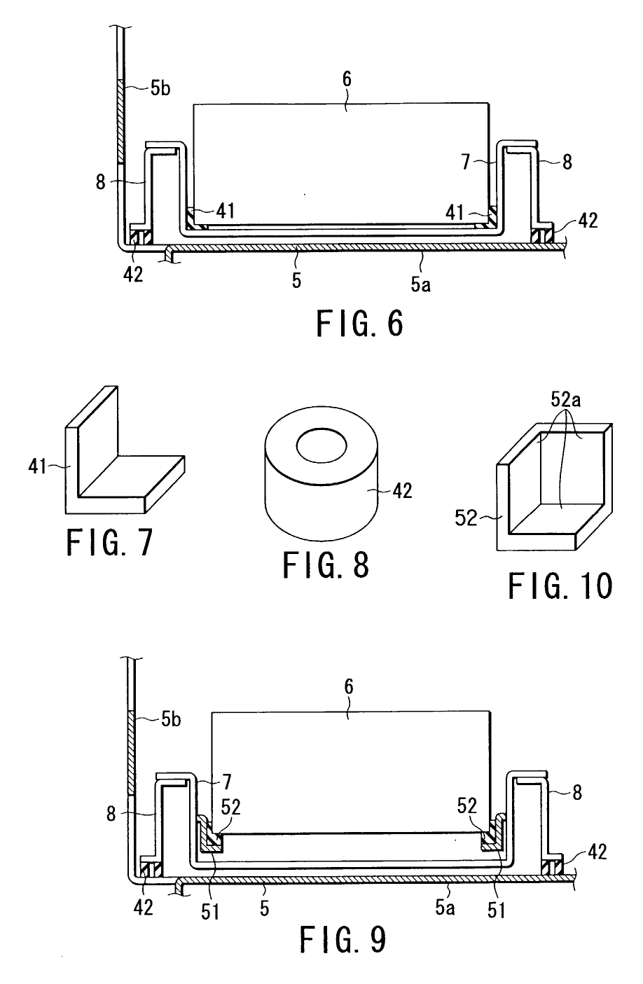

The invention is not limited to the first embodiment described above. The second embodiment of the invention will be shown in FIG. 6 to FIG. 8.

The second embodiment differs from the first embodiment as to the structure of supporting the hard disk drive 6 in the first housing 5. The basic structure of the electronic apparatus 1 other than the above supporting structure is the same as one according to the first embodiment. Therefore, in the second embodiment, the identical constituents to the first embodiment are marked with the identical symbols, and detailed descriptions will be omitted.

A plurality of fifth dampers 41 shown in FIG. 7 is interposed between the first bracket 7 and the hard disk drive 6. The respective fifth dampers 41 are formed of a rubber-like elastic body that can be elastically deformed, or are made of a gel material, and arranged in plural corners of the hard disk drive 6. Each of the fifth dampers 41 has a L-shaped sectional form that partly covers from the bottom to the side of the hard disk drive 6.

A plurality of second brackets 8 is supported on the bottom 5a of the first housing 5 through sixth dampers 42. Each of the sixth dampers 42 is formed of a rubber-like elastic body that can be elastically deformed, or is made of a gel material. The sixth damper 42 has a cylindrical shape as shown in FIG. 8.

According to the construction described above, even in the case where the feeble vibration to be transmitted to the base 12 is not totally absorbed by the first dampers 13 and the third dampers 24, the vibration is absorbed by the fifth dampers 41 and the sixth dampers 42, thereby being damped. As a result, the transmission of the vibration transmitted from the loudspeakers 16 to the hard disk drive 6 can be cut off unfailingly.

FIGS. 9 and 10 show the third embodiment of the invention.

The third embodiment is directed to a modification to the second embodiment. As shown in FIG. 9, a plurality of holders 51 is attached to the first bracket 7 so as to receive plural corners of the hard disk drive 6. The holders 51 are positioned above the bottom of the first bracket 7. Fifth dampers 52 are interposed between the holders 51 and the plural corners of the hard disk drive 6. Each of the fifth dampers 52 has three planes 52a, which come into contact with the bottom of the corner in the hard disk drive 6 and two sides adjacent to each other. Therefore, the hard disk drive 6 is held in the first housing 5 in the state where the drive is floating above the bottom of the first bracket 7.

The electronic apparatus according to the invention is not limited to one that is connected to a portable computer for use. The apparatus may be one that functions individually.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a first unit including an electronic device and a first supporting member;
a first damper attached to the first supporting member for absorbing vibration;
a second unit having a vibration generating device and a second supporting member, the second unit connected to the first unit; and
a second damper attached tot the second supporting member for absorbing vibration.

2. The electronic apparatus according to claim 1, further comprising:
a connecting member which connects the first unit and the second unit; a third damper interposed between the connecting member and the first unit, which absorb vibration; and a fourth damper interposed between the connecting member and the second unit, which absorb vibration.

3. The electronic apparatus according to claim 1, wherein the first unit has a first housing which contains the electronic device, the second unit has a second housing which contains the vibration generating device, and the first housing and the second housing are adjacent to each other with a space therebetween.

4. The electronic apparatus according to claim 2, wherein the first to fourth damper are rubber-like elastic bodies which can be deformed elastically.

5. The electronic apparatus according to claim 2, wherein the second damper and the fourth damper are mutually piled.

6. The electronic apparatus according to claim 4, further comprising:
a stopper mechanism which maintains the relative position between the first unit and the second unit uniformly, the stopper mechanism being interposed between the first unit and the second unit at the position far from the connecting member.

7. The electronic apparatus according to claim 1, wherein the electronic device is a hard disk drive, and the vibration generating device is a loudspeaker.

8. The electronic apparatus according to claim 3, wherein the electronic device is supported by the first housing through brackets, a fifth damper which absorb vibration are interposed between the bracket and the electronic device, and a sixth damper which absorb vibration are interposed between the bracket and the first housing.

9. An electronic apparatus comprising:
a first unit including an electronic device and a first supporting member;
a first damper attached to the first supporting member for absorbing vibration;
at least one second unit having a vibration generating device and a second supporting member;
a second damper attached to the second supporting member for absorbing vibration; and
a connecting member extending over the first unit and the second unit, the connecting member being connected to the first unit through a third damper which absorb vibration, and the connecting member being connected to the second unit through a fourth damper which absorb vibration.

10. The electronic apparatus according to claim 9, wherein the first unit has a first housing which contains the electronic device, the second unit has a second housing which contains the vibration generating device, the first housing and the second housing are arranged side by side with a space therebetween.

11. The electronic apparatus according to claim 9, wherein the first to fourth damper are rubber-like elastic bodies which can be deformed elastically.

12. The electronic apparatus according to claim 10, further comprising:
a stopper mechanism which maintains the relative position between the first unit and the second unit uniformly, the stopper mechanism being interposed between the first unit and the second unit at the position far from the connecting member.

13. The electronic apparatus according to claim 11, wherein in the case where a plurality of second units exist, the first unit is disposed between the plural second units.

14. The electronic apparatus according to claim 12, wherein the stopper mechanism includes a first engaging member attached to the first unit and a second engaging member attached to the second unit, the first and second engaging members engage with each other in the case where the first unit and the second unit are about to move toward a direction of moving away from each other so as to maintain the position relation between the first unit and the second unit.

15. An electronic apparatus comprising:
a first unit including a first housing equipped with a first component, the first housing having a first supporting member;
a first rubber-like elastic body attached to the first supporting member for absorbing vibration;
at least one second unit including a second housing equipped with a second component which causes vibration during its operation, the second housing being adjacent to the first housing and having a second supporting member;
a second rubber-like elastic body attached to the second supporting member for absorbing vibration;
a connecting member extending over the first housing and the second housing, the connecting member being connected to the first housing through a third rubber-like elastic body which absorb vibration, and the connecting member being connected to the second housing through a fourth rubber-like elastic body which absorb vibration; and
a stopper mechanism interposed between the first housing and the second housing, which maintains the relative position between the first unit and the second unit uniformly.

16. An electronic apparatus comprising:
a first unit having a first housing equipped with an electronic device;
a damper attached to the first housing for absorbing vibration;
at least one second unit having a second housing equipped with a vibration generating device; and
a connecting member extending over the first housing and the second housing, the connecting member is connected to the first housing and the second housing independently through respective dampers which absorb vibration.
